(19) United States
(12) Patent Application Publication
(10) Pub. No.: US 2013/0122805 A1
(43) Pub. Date: May 16, 2013

(54) COMMUNICATION APPARATUS AND CONTROL METHOD THEREOF

(71) Applicant: CANON KABUSHIKI KAISHA, Tokyo (JP)

(72) Inventor: Takatoshi Hirose, Yokohama-shi (JP)

(73) Assignee: CANON KABUSHIKI KAISHA, Tokyo (JP)

(21) Appl. No.: 13/654,945

(22) Filed: Oct. 18, 2012

(30) Foreign Application Priority Data
Nov. 16, 2011 (JP) 2011-251018
Sep. 26, 2012 (JP) 2012-212968

(51) Int. Cl. H04B 5/00

(52) U.S. Cl. 455/41.1

(57) ABSTRACT

A first user instruction for turning on a communication unit of a communication apparatus is detected. An instruction which is performed firstly, out of the first user instruction and a second user instruction for turning on a communication unit of the other communication apparatus, is determined. Based on this determination result, data designated by a user is transmitted from the communication apparatus to another communication apparatus.

### BACKGROUND OF THE INVENTION

1. Field of the Invention

The present invention relates to a communication technique and, more particularly, to near field communication.

2. Description of the Related Art

There is available a wireless communication system in which communication terminals each having a near field communication function can exchange data using near field communication. The communication terminals which exchange data can establish wireless connection by making their near field communication antennas come close to each other and further making the antennas come closer to each other.

Near field communication having a very short communicable distance can easily identify a network and is almost free from eavesdropping. Accordingly, designating a network identifier, inputting a password, and the like can be omitted. For this reason, near field communication features that a wireless link can be connected by a simple operation, that is, making the terminals to be communicated come close to each other.

When the wireless link of near field communication is set in a connected state, one communication terminal can transfer user data such as image data and document data to the other communication terminal using various kinds of applications running in these communication terminals.

There are available a method of determining the source communication terminal and the destination communication terminal for transferring the user data and the transfer direction by a user operation before the connection and a method of interactively selecting them at the time of communication. More specifically, a user operates one communication terminal to set an application in a reception mode, while a partner operates the other communication terminal to set an application in a transmission mode.

As another method, the user operates one communication terminal to start up a reception application, while the partner operates the other communication terminal to start up a transmission application.

As still another method, while one communication terminal is set in a standby mode upon running the application in the reception mode, the user operates the other communication terminal to set the application in the transmission mode.

A touch panel display is available as an operation technique in recent communication terminals. Using a touch panel display, the user can touch various types of objects such as buttons and icons displayed on the touch panel display with a finger or pen. The user can also input information by moving a finger to trace the panel of the touch panel display. This makes it possible to omit input parts such as buttons.

In addition, the touch panel display is used for not only simple actions such as pressing of buttons but also display of objects depending on situations and actions for these objects. This allows the user to perform more intuitive simple operations.

There is proposed a method for determining the transfer direction of user data with an intuitive operation by using a technique for detecting an operation direction using a motion sensor (Japanese Patent Laid-Open No. 2010-045681). According to the control of this method, an apparatus B is made to approach close to an apparatus A to establish near field communication connection. Thereafter, when the user displaces the apparatus B to direct it to a direction in which the apparatus B sends information to the apparatus A, the apparatus B transfers data to the apparatus A. When the apparatus B is displaced to turn back away from the apparatus B, the apparatus A transfers data to the apparatus B.

As described above, there are available communication apparatuses capable of establishing wireless link connections with a simple operation, that is, making the mating communication apparatuses come close to each other. However, in the conventional near field communication system, although the wireless link connection is established by making the mating communication apparatuses come close to each other, a nonintuitive operation, that is, an operation of determining the transfer direction of user data on the application is required.

Even if one communication apparatus is always set in the standby mode to omit operation procedures, this operation cannot be regarded as an intuitive operation. This wastes power while in the standby mode.

Although an example using a motion sensor is also proposed, the power in the standby mode during near field communication cannot be suppressed, provided that an intuitive operation is disclosed.

### SUMMARY OF THE INVENTION

The present invention has been made in consideration of the above problems and provides a technique for determining the transfer direction of data with an intuitive operation.

According to one aspect of the present invention, there is provided a communication apparatus comprising: a detection unit configured to detect a first user instruction for turning on a communication unit in the communication apparatus; a determination unit configured to determine, out of the first user instruction detected by the detection unit and a second user instruction for turning on a communication unit of another communication apparatus, an instruction which is performed firstly; and a data communication unit configured to transmit or receive data designated by a user between the communication apparatus and the other communication apparatus based on a determination result of the determination unit.

According to another aspect of the present invention, there is provided a control method of a communication apparatus, comprising: a detection step of detecting a first user instruction for turning on a communication unit of the communication apparatus; a determination step of determining, out of the first user instruction detected in the detection step and a second user instruction for turning on a communication unit of another communication apparatus, an instruction which is performed firstly; and a communication step of transmitting or receiving data designated by a user between the communication apparatus and the other communication apparatus based on a determination result in the determination step.

Further features of the present invention will become apparent from the following description of exemplary embodiments with reference to the attached drawings.

### BRIEF DESCRIPTION OF THE DRAWINGS

FIG. 1 is a block diagram showing an example of the functional arrangement of a wireless communication apparatus 101;

FIG. 2 is a view showing a state of near field communication by making two wireless communication apparatuses come close to each other;

FIGS. 3A and 3B are timing charts for exchanging data between two wireless communication apparatuses;

FIGS. 4A and 4B are timing charts for exchanging data between two wireless communication apparatuses;

FIGS. 5A and 5B are flowcharts of processing performed by the wireless communication apparatus 101;

FIGS. 6A and 6B are flow charts of processing performed by the wireless communication apparatus 101;

FIG. 7 is a view showing a state in which a data file/folder 701 is displayed;

FIG. 8 is a view showing an example of a table describing operation rules of the wireless communication apparatus; and

FIG. 9 is a view showing an example of a table describing operation rules of the wireless communication apparatus.

### DESCRIPTION OF THE EMBODIMENTS

Embodiments of the present invention will be described with reference to the accompanying drawings. Note that the embodiments to be described below are merely examples which practice the present invention without departing from the scope of the appended claims.

### First Embodiment

In this embodiment, a digital camera is exemplified as a wireless communication apparatus having a near field communication (noncontact communication) function. A case in which images, folders, and the like are exchanged between wireless communication apparatuses using the near field communication function will be described.

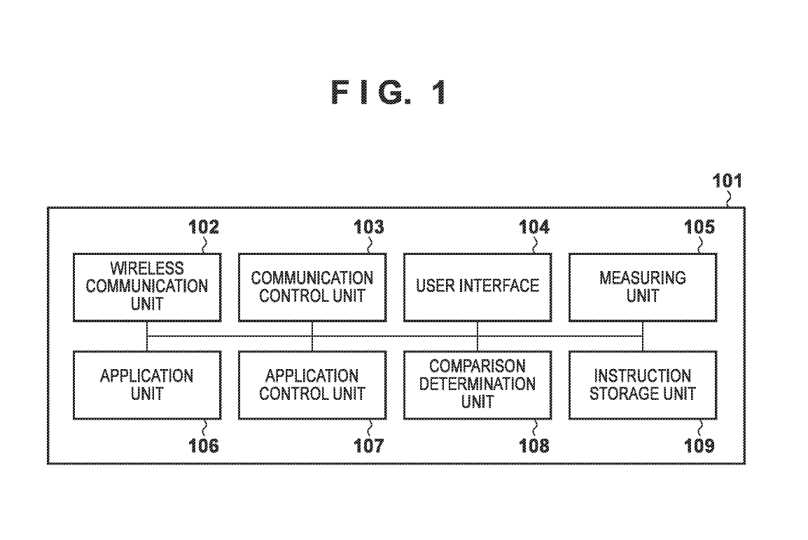

An example of the functional arrangement of a wireless communication apparatus 101 according to this embodiment will be described with reference to the block diagram of FIG. 1. FIG. 1 does not illustrate all the components of the wireless communication apparatus 101, but illustrates main components to be used in the following processing. That is, other components may be added to the wireless communication apparatus 101 depending on the application purpose. For example, when the wireless communication apparatus 101 is applied to the digital camera as in this embodiment, an image capturing unit including an optical system and an image sensor, a shutter, and the like may be added to the arrangement shown in FIG. 1.

The respective units shown in FIG. 1 may be formed from hardware or the units except a wireless communication unit 102 and a user interface 104 may be formed from software. In the latter case, the software is stored in an appropriate memory in the wireless communication apparatus 101 and executed by the processor of the wireless communication apparatus 101.

Some of the units shown in FIG. 1 may be appropriately integrated, or one component may be divided into a plurality of components. That is, the arrangement shown in FIG. 1 may be modified as needed as long as the processes to be described below can be implemented.

The wireless communication unit 102 exchanges data (data files and folders) with a wireless communication partner using the near field communication function. TransferJet, NFC, or the like is applicable as a near field transfer scheme. A communication control unit 103 controls the operation of the wireless communication unit 102.

The communication control unit 103 instructs the establishment and disconnection of a wireless connection (wireless link) and controls data transmission. In the near field communication of this embodiment, establishment (connection) of a wireless link is complete and a data communicable state is set when a connection request and a connection response are completely transmitted/received.

The user interface 104 includes a display screen for displaying an image, operation menu, data transmission status, data holding status, and other various kinds of information. The user interface 104 also includes an operation unit operated to input various kinds of instructions from the user. In this embodiment, the user interface 104 includes a touch panel screen. Although described in detail later, a power-on instruction (that is, an instruction for enabling the near field communication function) to the wireless communication unit 102 is performed by a user's tap operation on the touch panel screen.

A measuring unit 105 measures time using a timer. In this embodiment, the measuring unit 105 measures, as an elapsed time (first elapsed time), a time from detection of a near filed wireless communication function ON instruction to detection of establishment of wireless communication with a wireless communication partner.

An application unit 106 manages a transmission application for transmitting a data file held in the wireless communication apparatus 101 to the wireless communication partner and a reception application for receiving a data file transmitted from the wireless communication partner. The application unit 106 starts up and executes one of the two applications which is designated by an application control unit 107. Note that the application unit 106 may manage applications other than the above two applications and starts up and executes an application in accordance with a user instruction or depending on situations.

An application control unit 107 basically interfaces a message between the communication control unit 103 and the application unit 106. The application control unit 107 sends an instruction for an application to be executed to the application unit 106 and causes the application unit 106 to start up and execute the instructed application.

A comparison determination unit 108 compares the elapsed time measured by the measuring unit 105 with an elapsed time (second elapsed time) measured on the wireless communication partner side. The comparison determination unit 108 instructs the application control unit 107 to start up and execute one of the transmission application and the reception application which is in advance associated with the comparison result.

Out of the data files and folders displayed on the touch panel screen, an instruction storage unit 109 stores a target designated by a user's tap operation. The target to be stored is transmitted to the wireless communication partner by executing the transmission application.

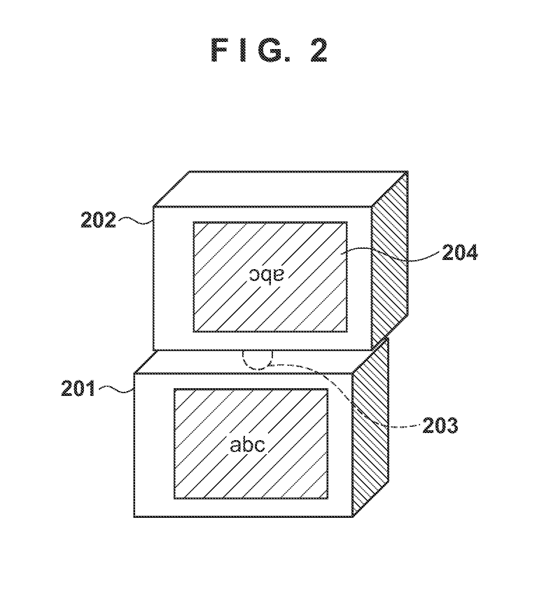

A state in which two wireless communication apparatuses are made to come close to each other to perform near field communication will be described with reference to FIG. 2. In FIG. 2, a wireless communication apparatus 201 and a wireless communication apparatus 202 are made to come close to each other. Each of the wireless communication apparatus 201 and the wireless communication apparatus 202 has the arrangement shown in FIG. 1.

The wireless communication apparatus 201 includes a touch panel screen serving as the user interface 104 and a near field communication interface 203 serving as the wireless communication unit 102. Similarly, the wireless communication apparatus 202 includes a touch panel screen 204 serving as the user interface 104 and a near field communication interface (not shown). These communication apparatuses perform near field communication via the near field communication interface. Note that the near field communication interface may be incorporated in the wireless communication apparatus or may be externally connected via a cable or the like.

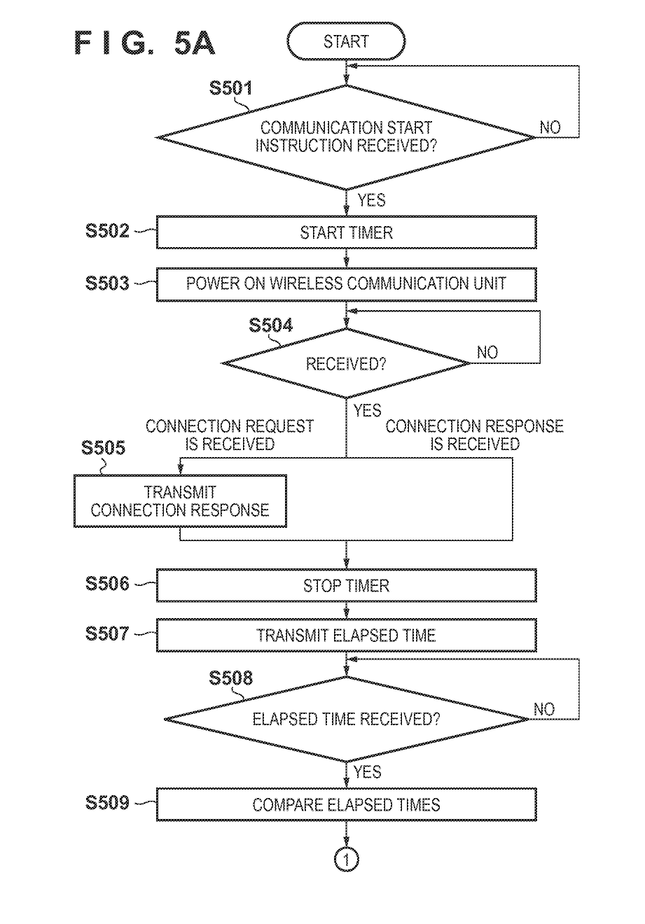

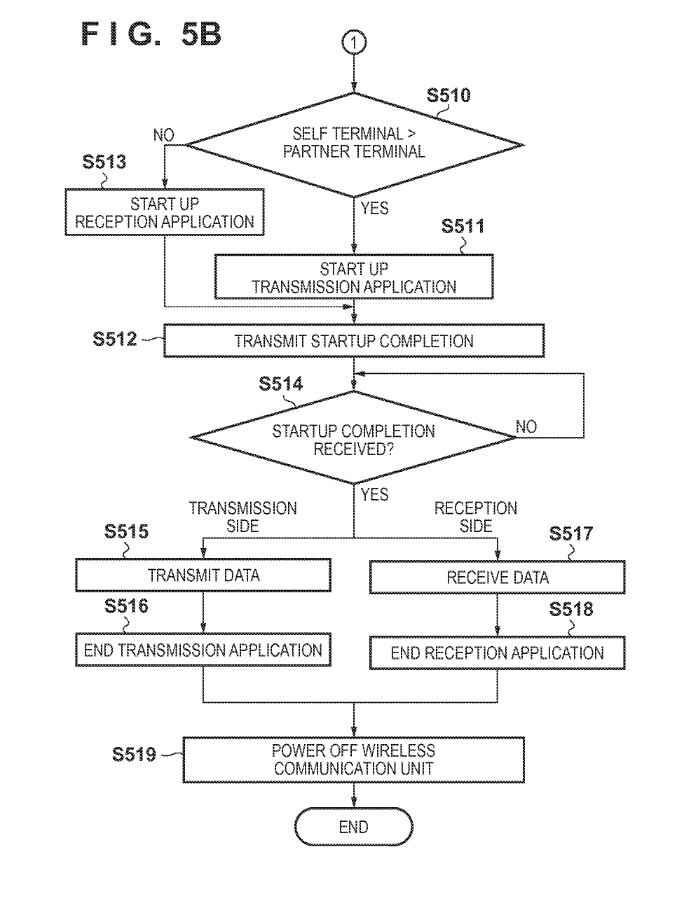

Processing performed by the wireless communication apparatus 101 with the wireless communication partner will be described with reference to FIGS. 5A and 5B illustrating the flowchart of this processing. Note that the wireless communication partner also has the same arrangement as in FIG. 1 and performs processing according to the flowcharts in FIGS. 5A and 5B.

In the following description, the user interface 104 of the wireless communication apparatus 101 displays a plurality of data files and folders. The user taps the display position of a desired data file/folder, and the instruction storage unit 109 stores the data file/folder displayed at the tapped position as a transmission target.

When the user taps at least one of the points (one point except a region where the data files and folders are displayed) on the screen of the user interface 104, the user interface 104 notifies the application control unit 107 of this. A position to be tapped may be a specific position (for example, a display region of a button for enabling the near field communication function) or an arbitrary position.

By this notification, the application control unit 107 sends a power-on instruction for the wireless communication unit 102 to the communication control unit 103. The communication control unit 103 powers on the wireless communication unit 102. This makes it possible to enable the near field communication function.

A series of processes are also performed on the wireless communication partner side. When the wireless communication apparatus 101 and the wireless communication partner have performed the above processes, the near field communication can be performed between the apparatuses upon making them come close to each other because the near field communication function of the apparatuses is enabled.

In step S501 in FIG. 5A, the user interface 104 determines whether at least one of the points on the screen of the user interface 104 is tapped during the display of the plurality of data files and folders. In other words, this determination is to determine whether an instruction for enabling the near field communication function is input. As a result of this determination, when one point is tapped, the process advances to step S502; otherwise, the process returns to step S501.

In step S502, upon receiving information indicating the tapped point from the user interface 104, the application control unit 107 sends an instruction for starting time measurement to the measuring unit 105. The measuring unit 105 starts time measurement using a timer.

In step S503, the application control unit 107 sends a power-on instruction for the wireless communication unit 102 to the communication control unit 103. The communication control unit 103 powers on the wireless communication unit 102.

In step S504, the communication control unit 103 controls the wireless communication unit 102 to transmit a connection request periodically or irregularly and determines whether the wireless communication unit 102 receives a response to this connection request (connection response) or a connection request transmitted by the other wireless communication apparatus. As a result of this determination, when the wireless communication unit 102 receives neither the connection response nor the connection request, the process returns to step S504 to continuously transmit a connection request. Upon receiving the connection request, the process advances to step S505. When the connection response is received, the process advances to step S506.

Even if the wireless communication unit 102 receives either the connection request or the connection response, the communication control unit 103 notifies the application control unit 107 that the wireless connection with the reception side is established (connection completion). This reception side is the wireless communication partner.

In step S505, the communication control unit 103 controls the wireless communication unit 102 to allow the wireless communication unit 102 to transmit, to the wireless communication partner, the connection response to the connection request received from the wireless communication partner.

In step S506, the application control unit 107 sends an instruction to stop time measurement to the measuring unit 105. The measuring unit 105 stops measuring the time using the timer. At this time, the count value of the timer indicates the time from detection of the near field communication function ON instruction to the detection of establishment of the wireless connection with the wireless communication partner. The comparison determination unit 108 obtains this count value as the elapsed time.

In step S507, the communication control unit 103 controls the wireless communication unit 102 to transmit the elapsed time specified in step S506 to the wireless communication partner. Note that the wireless communication partner also performs the same processing as described above, so the communication control unit 103 waits until transmission of the elapsed time measured on the wireless communication partner side.

In step S508, the communication control unit 103 determines whether the elapsed time is received from the wireless communication partner. As a result of this determination, when the elapsed time is received, the process advances to step S509; otherwise, the process returns to step S508 to wait for reception.

When the wireless communication unit 102 receives the elapsed time transmitted from the wireless communication partner, the communication control unit 103 transmits the received elapsed time to the comparison determination unit 108. In step S509, the comparison determination unit 108 compares the elapsed time (the elapsed time measured by the measuring unit 105 in the wireless communication apparatus 101) received from the measuring unit 105 with the elapsed time (the elapsed time measured on the wireless communication partner side) received from the communication control unit 103.

As a result of comparison, if (the elapsed time measured by the measuring unit 105 in the wireless communication apparatus 101)>(the elapsed time received from the communication control unit 103), the process advances to step S511. To the contrary, if (the elapsed time measured by the measuring unit 105 in the wireless communication apparatus 101)≦(the elapsed time received from the communication control unit 103), the process advances step S513.

In step S511, the comparison determination unit 108 sends a transmission application startup instruction to the application control unit 107. The application control unit 107 sends the transmission application startup instruction to the application unit 106. This makes it possible to allow the application unit 106 to start up the transmission application.

In step S513, the comparison determination unit 108 sends a reception application startup instruction to the application control unit 107. The application control unit 107 sends the reception application startup instruction to the application unit 106. This makes it possible to allow the application unit 106 to start up the reception application.

In step S512, when the application unit 106 completes the application startup, the communication control unit 103 uses the wireless communication unit 102 to notify the wireless communication partner of the completion of application startup.

When the wireless communication partner side completes the application startup, it sends the message indicating the completion of the application startup. The communication control unit 103 waits for reception of the message indicating the completion of the application startup from the wireless communication partner. The communication control unit 103 determines in step S514 whether the message indicating the completion of the application startup is received from the wireless communication partner. As a result of this determination, if the communication control unit 103 does not receive the message, the process returns to step S514 to wait for the reception of this message. On the other hand, upon receiving the message, the process advances to step S515 or S517. When the application unit 106 has started up the transmission application, the process advances to step S515. When the application unit 106 has started up the reception application, the process advances to step S517.

In step S515, the application unit 106 executes the transmission application to control the communication control unit 103. The communication control unit 103 causes the wireless communication unit 102 to transmit the transmission target stored in the instruction storage unit 109 to the wireless communication partner. In step S516, the application control unit 107 ends the transmission application.

In step S517, the application unit 106 executes the reception application to control the communication control unit 103. The communication control unit 103 causes the wireless communication unit 102 to receive the data file/folder transmitted from the wireless communication partner. In step S518, the application control unit 107 ends the reception application.

In the above description, if (the elapsed time measured by the measuring unit 105 in the wireless communication apparatus 101)>(the elapsed time received from the communication control unit 103), the transmission application is started up and executed. If (the elapsed time measured by the measuring unit 105 in the wireless communication apparatus 101)≦(the elapsed time received from the communication control unit 103), the reception application is started up and executed. However, if (the elapsed time measured by the measuring unit 105 in the wireless communication apparatus 101)>(the elapsed time received from the communication control unit 103), the reception application may be started up and executed. If (the elapsed time measured by the measuring unit 105 in the wireless communication apparatus 101)≦(the elapsed time received from the communication control unit 103), the transmission application may be started up and executed. That is, out of the transmission application and the reception application, the application associated with the comparison result of the elapsed times is started up and executed.

If (the elapsed time measured by the measuring unit 105 in the wireless communication apparatus 101)≈(the elapsed time received from the communication control unit 103), the data transfer between the wireless communication apparatuses may be stopped.

In step S519, the application control unit 107 sends an instruction for disconnecting the wireless connection with the wireless communication partner to the communication control unit 103. The communication control unit 103 disconnects the wireless connection with the wireless communication partner. In addition, the application control unit 107 sends an instruction for disconnecting power to the wireless communication unit 102 to the communication control unit 103. The communication control unit 103 disconnects the power to the wireless communication unit 102, thereby disabling the near field communication function.

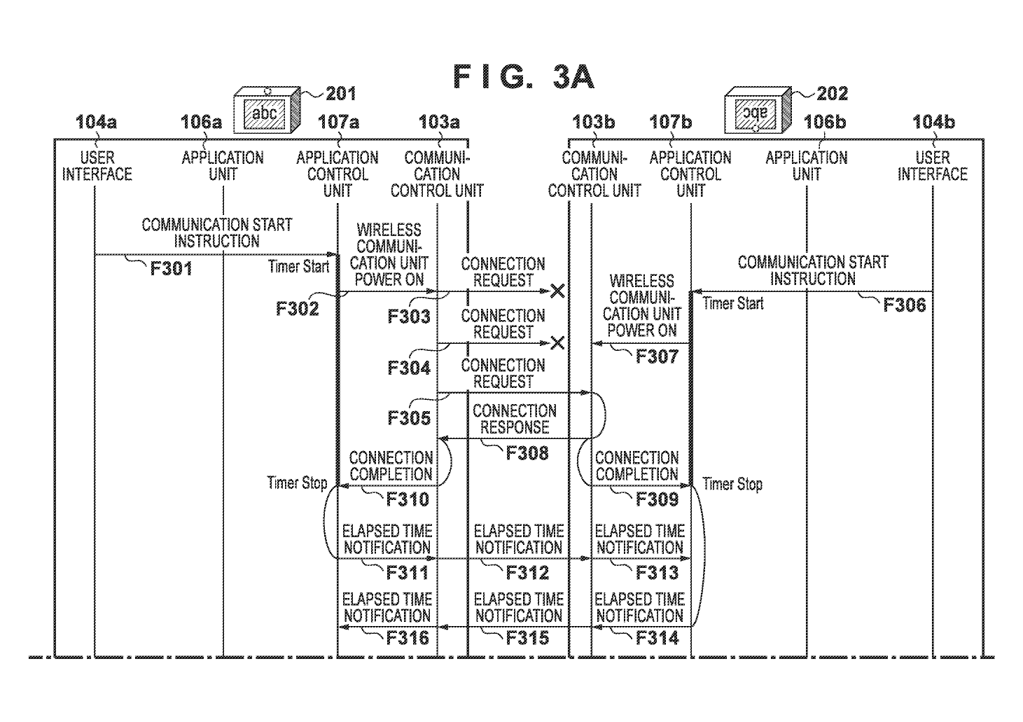

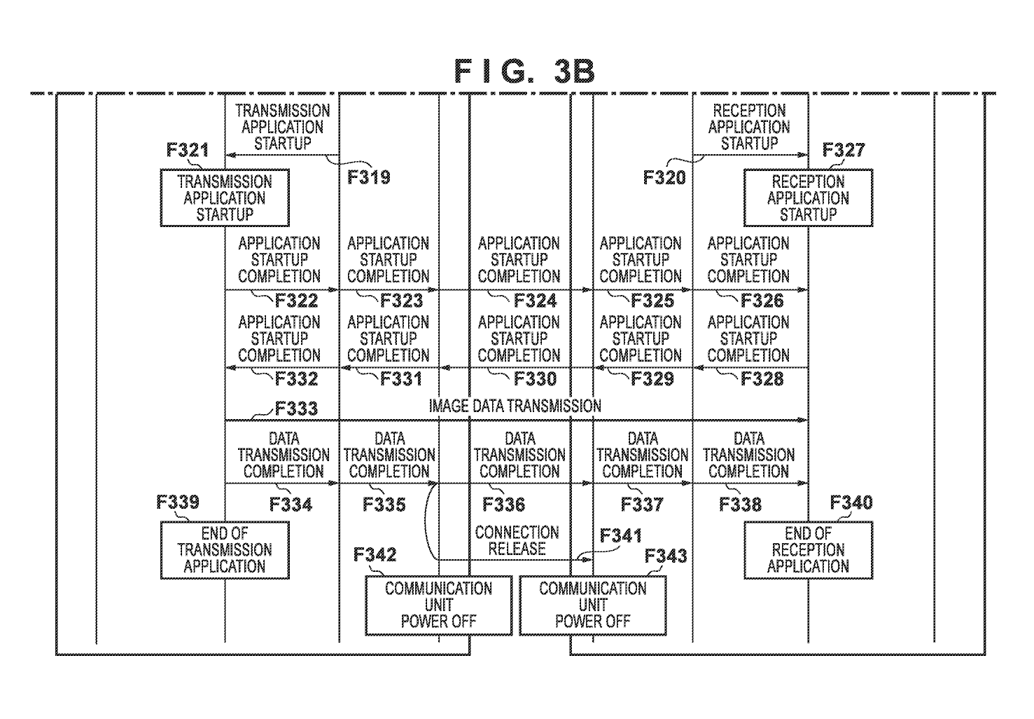

The data exchange between the two wireless communication apparatuses 201 and 202 which perform wireless communication in accordance with the flowcharts of FIGS. 5A and 5B will be described with reference to the timing charts of FIGS. 3A and 3B. Assume that these two wireless communication apparatuses 201 and 202 have the same arrangement as shown in FIG. 1, a is suffixed to the reference numerals for the components of the wireless communication apparatus 201, while b is suffixed to the reference numerals for the components of the wireless communication apparatus 202.

A user interface 104a inputs a message indicating a tapped state (communication start instruction) to an application control unit 107a (F301). Upon receiving the communication start instruction, the application control unit 107a sends a time measurement start instruction to a measuring unit 105a. At the same time, the application control unit 107a sends an instruction for powering on a wireless communication unit 102a to a communication control unit 103a (F302). The communication control unit 103a causes the wireless communication unit 102a to transmit a connection request periodically or irregularly (F303 to F305). Note that the wireless communication apparatus 202 performs the same operations as described above (F306 and F307).

In FIGS. 3A and 3B, a communication control unit 103b in the wireless communication apparatus 202 transmits a connection response to the connection request transmitted in F305 to the wireless communication apparatus 201 (F308). Upon receiving this connection response, the communication control unit 103a notifies the application control unit 107a that the wireless connection is established with the wireless communication apparatus 202 (connection completion) (F310). The communication control unit 103b notifies an application control unit 107b that the wireless connection with the wireless communication apparatus 201 is established (connection completion) (F309).

The application control units 107a and 107b send time measurement stop instructions to the measuring unit 105a and a measuring unit 105b, respectively. Comparison determination units 108a and 108b obtain the count values as the elapsed times, respectively.

The application control unit 107a notifies the communication control unit 103a of the elapsed time measured by the measuring unit 105a (F311). The communication control unit 103a transmits this elapsed time to the wireless communication apparatus 202 (F312). The communication control unit 103b notifies the application control unit 107b of the elapsed time received from the wireless communication apparatus 201 (F313).

Similarly, the application control unit 107b notifies the communication control unit 103b of the elapsed time measured by the measuring unit 105b (F314). The communication control unit 103b transmits this elapsed time to the wireless communication apparatus 201 (F315). The communication control unit 103a notifies the application control unit 107a of the elapsed time received from the wireless communication apparatus 202 (F316).

The exchange order of the elapsed times need not be limited to the above order. The wireless communication apparatus 202 transmits the elapsed time first, and then the wireless communication apparatus 201 transmits the elapsed time.

The comparison determination units 108a and 108b compare the elapsed times received from the measuring units 105a and 105b with the elapsed times receiving from the wireless communication partners, respectively. In FIGS. 3A and 3B, as a result of this comparison, the following decisions are made. The wireless communication apparatus 201 starts up and executes the transmission application, while the wireless communication apparatus 202 starts up and executes the reception application.

The application control unit 107a sends a transmission application startup instruction to an application unit 106a (F319). The application unit 106a then starts up the transmission application (F321).

Upon completion of the transmission application startup, this message is transmitted to the wireless communication apparatus 202 via the application control unit 107a and the communication control unit 103a (F322 to F324). In addition, this message is also notified to an application unit 106b via the communication control unit 103b and the application control unit 107b (F325 and F326).

The application control unit 107b sends a reception application startup instruction to the application unit 106b (F320). The application unit 106b starts up the reception application (F327).

Upon completion of the reception application startup, this message is transmitted to the wireless communication apparatus 201 via the application control unit 107b and the communication control unit 103b (F328 to F330). This message is also notified to the application unit 106a via the communication control unit 103a and the application control unit 107a (F331 and F332).

The application unit 106a executes the transmission application to control the communication control unit 103a to cause the wireless communication 102a to transmit the transmission target (in this case image data) stored in an instruction storage unit 109a to the wireless communication apparatus 202 (F333).

Upon completion of this data transmission, the message indicating the completion of the data transmission is notified to the application unit 106b via the application control unit 107a, the communication control unit 103a, the communication control unit 103b, and the application control unit 107b (F334 to F338).

The application control units 107a and 107b end the transmission application and the reception application, respectively (F339 and F340).

The application control units 107a and 107b send instructions for disconnecting wireless connections with the wireless communication partners to the communication control units 103a and 103b, respectively. The communication control units 103a and 103b disconnect the wireless connections with the wireless communication partners, respectively (F341). In addition, the communication control units 103a and 103b disconnect power to the wireless communication unit 102a and a wireless communication unit 102b, respectively (F342 and F343). The power saving state is set until the next wireless transfer.

In the above description, when the users make the wireless communication apparatus 201 and the wireless communication apparatus 202 come close to each other within a predetermined communication range, no wireless link is established and the wireless link is established after the user operations. However, the wireless link may be established when these apparatuses are made to come close to each other. In this case, the data transfer direction can be determined by measuring the elapsed times until the user operations after the establishment of the wireless link.

### Second Embodiment

This embodiment is different from the first embodiment in the following points. Only differences from the first embodiment will be described below. In the first embodiment, after a data file/folder serving as a transmission target is designated, the user taps an appropriate position on the user interface 104 to enable the near field communication function. However, according to the second embodiment, when the first data file/folder is designated, the near field communication function is enabled. The operation of the wireless communication apparatus for enabling the near field communication function is the same as in the first embodiment.

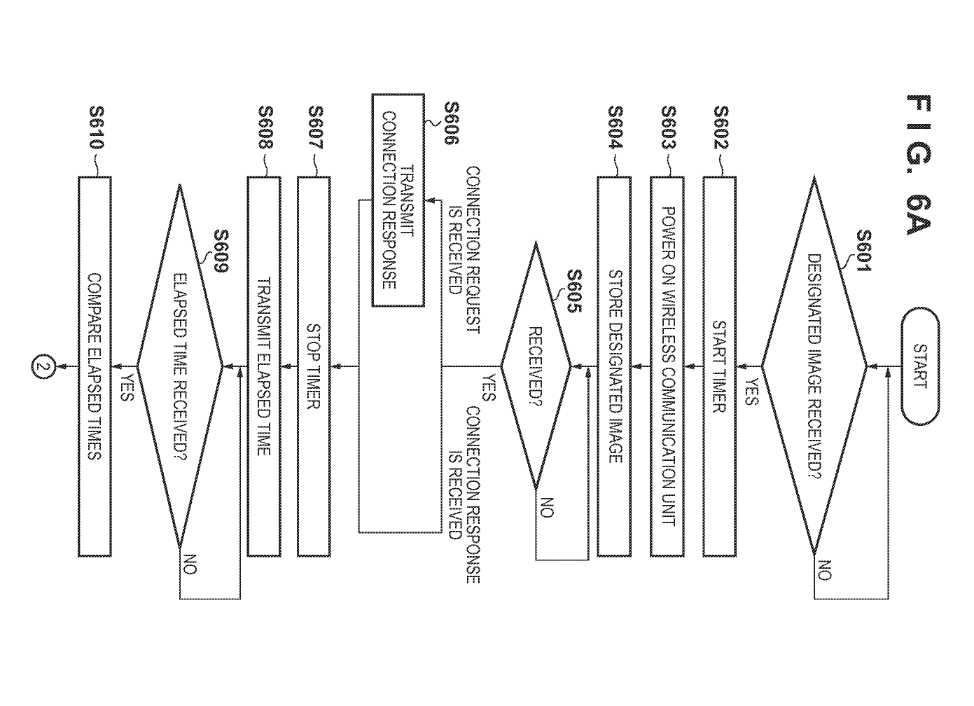

In the first embodiment, the two mating apparatuses determine whether one of the transmission application and the reception application is executed. In the second embodiment, however, an apparatus which has transmitted a connection request performs this determination. The processing performed by a wireless communication apparatus according to the second embodiment will be described with reference to FIGS. 6A and 6B illustrating the flowchart of this processing.

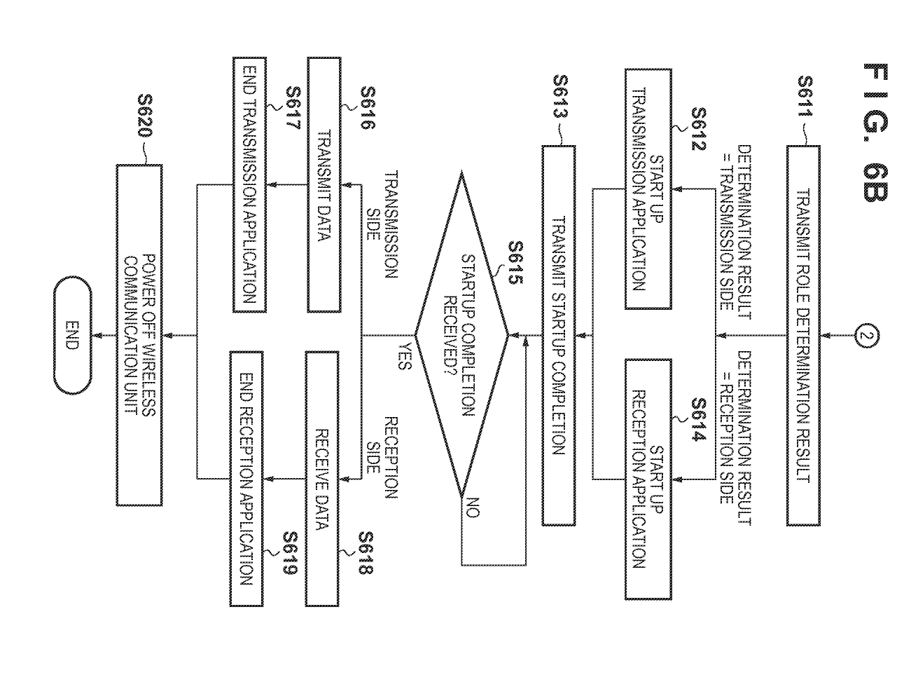

In step S601, a user interface 104 determines whether one of the data files and folders displayed on the screen is designated. FIG. 7 shows a state in which data files/folders 701 are displayed on the user interface 104.

As a result of this determination, if no data file/folder is designated, the process returns to step S601. On the other hand, if any one of the data files/folders is designated, the user interface 104 determines that an instruction for enabling a near field communication function is input. The process advances to step S602.

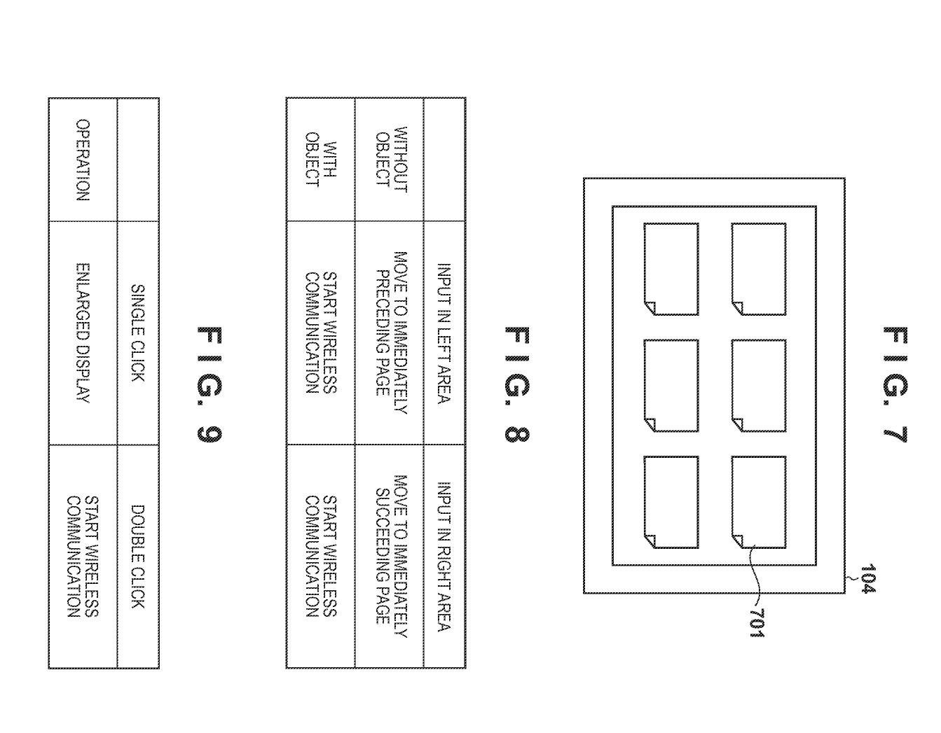

FIG. 8 shows an example of a table describing the operation rules of the wireless communication apparatus for various types of tap operations on the user interface 104. As shown in FIG. 8, in a state in which no data file/folder (object) is displayed, when the user taps a point in the left area, the user interface 104 determines that an operation for moving the page to the immediately preceding page is input. The immediately preceding page is then displayed. On the other hand, in a state in which no object is displayed, when the user taps a point in the right area, the user interface 104 determines that an operation for moving the page to the immediately succeeding page is input. The immediately succeeding page is then displayed.

In a state in which objects are displayed on the screen, when the user taps a point in the left or right area, the user interface 104 determines that an instruction for enabling the near field communication function is input.

FIG. 9 shows an example of a table describing operation rules of the wireless communication apparatus for various types of click operations on the user interface 104. As shown in FIG. 9, when the user performs a single click operation on the user interface 104, the user interface 104 enlarges the displayed screen. To the contrary, when the user performs a double click operation on the user interface 104, the user interface 104 determines that an instruction for enabling the near field communication function is input.

The user interface 104 manages these tables. These tables may be used in the first embodiment or the second embodiment. Note that the operation methods and corresponding operation rules registered in the tables may be changed as needed. Steps S602 and S603 are the same as steps S502 and S503, and a description thereof will not be repeated.

In step S604, every time the user interface 104 designates a data file/folder, an instruction storage unit 109 stores the designated data file/folder. Steps S605 to S609 are the same as steps S504 to S508, and a description thereof will not be repeated.

Processing in step S610 is performed only when a connection response is received from a wireless communication partner. In step S610, a comparison determination unit 108 compares elapsed times as in the first embodiment.

In step S611, when the connection response is received from the wireless communication partner, a communication control unit 103 controls a wireless communication unit 102 to transmit the comparison result in step S610 to the wireless communication partner. When a connection request is received from the wireless communication partner, the communication control unit 103 controls the wireless communication unit 102 to receive the comparison result transmitted from the wireless communication partner.

If (the elapsed time measured by a measuring unit 105 in a wireless communication apparatus 101)>(the elapsed time received from the communication control unit 103), the process advances to step S612. To the contrary, if (the elapsed time measured by the measuring unit 105 in the wireless communication apparatus 101)≦(the elapsed time received from the communication control unit 103), the process advances to step S614.

Steps S612 to S620 are the same as steps S511 to S519, and a description thereof will not be repeated.

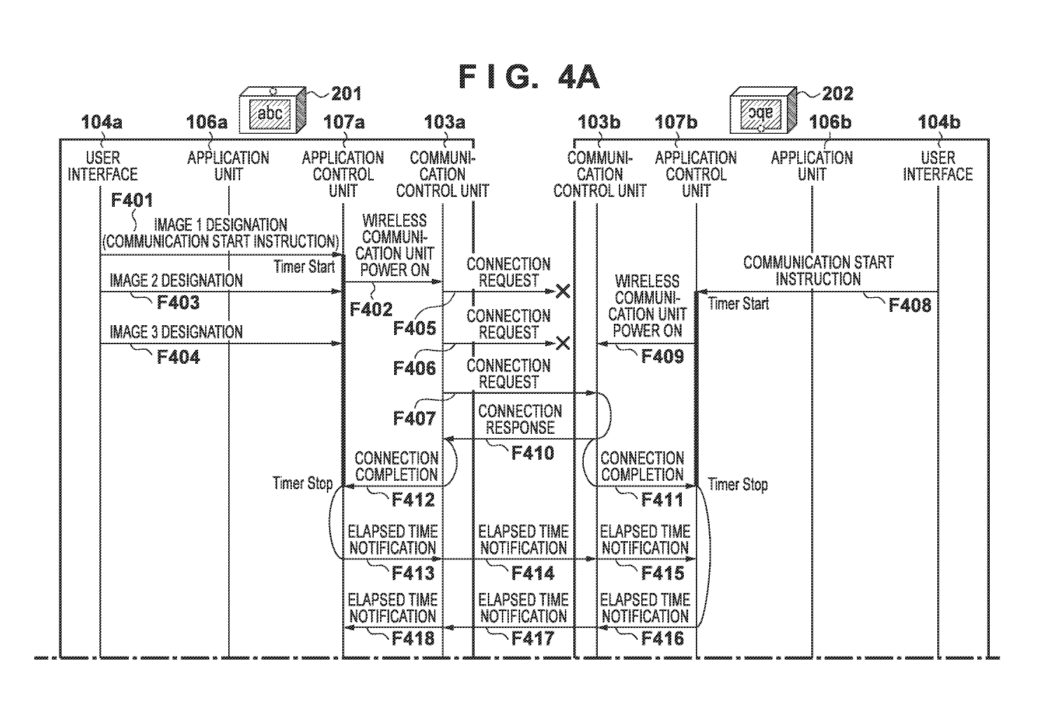

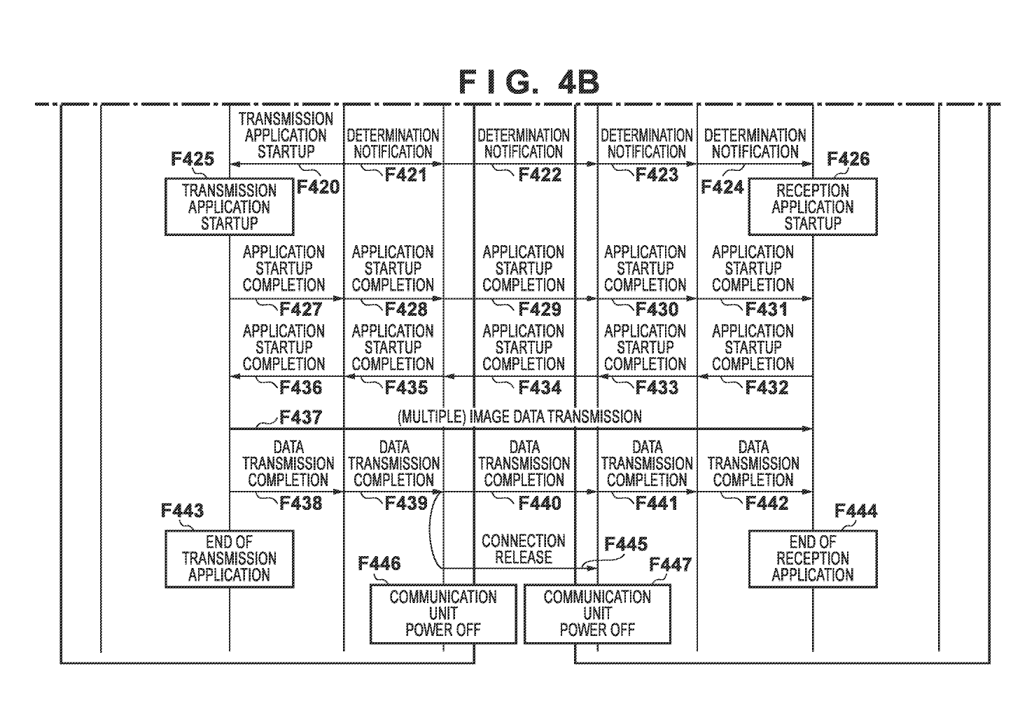

Data exchange between two wireless communication apparatuses 201 and 202 which perform wireless communication in accordance with the flowcharts of FIGS. 6A and 6B will be described using the timing charts in FIGS. 4A and 4B. Note that the two wireless communication apparatuses 201 and 202 have the same arrangement as in FIG. 1, and a is suffixed to the reference numerals for the components of the wireless communication apparatus 201, while b is suffixed to the reference numerals of the components of the wireless communication apparatus 202.

When a data file/folder (in this case image 1) is designated first, a user interface 104a inputs a message indicating the designation of the data file/folder (communication start instruction) to an application control unit 107a (F401). Data files/folders (images 2 and 3 in FIG. 4A) can be subsequently designated on the user interface 104a (F403 and F404).

Upon receiving the communication start instruction, the application control unit 107a sends a time measuring start instruction to a measuring unit 105a and a power-on instruction for a wireless communication unit 102a to the communication control unit 103a (F402).

F405 to F418 are the same as F303 to F316.

A comparison determination unit 108a compares the elapsed time received from the measuring unit 105a with the elapsed time received from the wireless communication partner. In FIGS. 4A and 4B, as a result of this comparison, the following decisions are made. The wireless communication unit 201 starts up and executes a transmission application, while the wireless communication unit 202 starts up and executes a reception application.

The application control unit 107a sends a transmission application startup instruction to an application unit 106a (F420). The application unit 106a starts up the transmission application (F425).

The application control unit 107a notifies a communication control unit 103a of the comparison result by the comparison determination unit 108a (F421). The communication control unit 103a transmits the comparison result to the wireless communication apparatus 202 (F422). A communication control unit 103b notifies an application control unit 107b of the comparison result received from the wireless communication apparatus 201 (F423).

The application control unit 107b sends a reception application startup instruction to an application unit 106b (F424). The application unit 106b starts up the reception application (F426).

Note that F427 to F431 are the same as F322 to F326, and that F432 to F447 are the same as F328 to F343. Note also that the first and second embodiments can be combined as needed.

In the above embodiments, the wireless communication apparatus 101 measures the first elapsed time from the detection of the near field communication function ON instruction in the apparatus 101 to the detection of the establishment of the wireless connection with the wireless communication partner. The wireless communication apparatus 101 obtains the second elapsed time from the detection of the near field communication function ON instruction in the wireless communication partner to the detection of the establishment of the wireless connection between the wireless communication partner and the wireless communication apparatus 101. The wireless communication apparatus 101 starts up one of the transmission application and the reception application based on the comparison result between the first elapsed time and the second elapsed time.

The present invention is not limited to this. The following arrangement may be made.

More specifically, the first timing at which the near field communication function ON instruction input is detected in the wireless communication apparatus 101 is stored in a memory (not shown). The wireless communication apparatus 101 received, from the wireless communication partner, the second timing at which the near field communication function ON instruction input is detected in the wireless communication partner.

The wireless communication apparatus 101 determines which one of the first timing and the second timing is earlier. The wireless communication apparatus 101 starts up one of the transmission application and the reception application based on the comparison result between the first timing and the second timing. For example, if the first timing is earlier than the second timing, the transmission application is started up. To the contrary, if the first timing is later than the second timing, the reception application is started up.

Note that in this case the wireless communication apparatus 101 notifies the wireless communication partner of the first timing information, so the wireless communication partner can start up an appropriate application (transmission application or reception application).

As described above, as in the first embodiment and the second embodiment, data designated by the user can be transmitted or received based on the fact that the user enables the near field communication function of either apparatus first.

The timings measured by the wireless communication apparatus 101 and the wireless communication partner may be different. In this case, pieces of timing information measured by the respective apparatuses are shared, and the first timing and/or the second timing is corrected based on the shared timing information. The pieces of corrected timing information may be compared with each other.

For example, assume that the first timing is 10:00:10 and the second timing is 10:00:05. Even in this case, assume that the timing measured by the wireless communication apparatus 101 is earlier than the timing measured by the wireless communication partner by 10 sec. In this case, the wireless communication apparatus 101 determines that the timing at which the near field communication function ON instruction input is detected in the wireless communication apparatus 101 is earlier than the timing at which the near field communication function ON instruction input is detected in the wireless communication partner.

As described above, even if the timings measured by the wireless communication apparatus 101 and the wireless communication partner are different from each other, it is determined based on the first timing information and the second timing information that the user enables the near field communication function of either apparatus first.

As in the first embodiment and the second embodiment, the data designated by the user can be transmitted or received based on the fact that the user enable the near field communication function of either apparatus first.

In prior art, when the transmission applications are started up in both the wireless communication apparatus and the wireless communication partner, an error may occur. In the above embodiments, since one apparatus starts up one of the transmission application and the reception application and another apparatus starts up another of the transmission application and the reception application, an error can be reduced at a high possibility.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2011-251018 filed Nov. 16, 2011 and 2012-212968 filed Sep. 26, 2012, which are hereby incorporated by reference herein in their entirety.

What is claimed is:

1. A communication apparatus comprising:
a detection unit configured to detect a first user instruction for turning on a communication unit in the communication apparatus;
a determination unit configured to determine, out of the first user instruction detected by said detection unit and a second user instruction for turning on a communication unit of another communication apparatus, an instruction which is performed firstly; and
a data communication unit configured to transmit or receive data designated by a user between the communication apparatus and the other communication apparatus based on a determination result of said determination unit.

2. The apparatus according to claim 1, further comprising:
a timer unit configured to measure a first elapsed time from detection of the first user instruction by said detection unit to detection of establishment of a wireless connection between the communication apparatus and the other communication apparatus; and
a reception unit configured to receive, from the other communication apparatus, a second elapsed time from detection of the second user instruction to detection of establishment of a wireless connection between the communication apparatus and the other communication apparatus,
wherein said determination unit compares the first elapsed time and the second elapsed time.

3. The apparatus according to claim 2, wherein said timer unit starts time measurement and turns on the communication unit of the communication apparatus upon detecting a user's tap operation on a touch panel screen of the communication apparatus, stops the time measurement upon detecting that the wireless connection is established between the communication apparatus and the other communication apparatus, and defines a time measured from the starting of the time measurement to the stopping of the time measurement as the first elapsed time.

4. The apparatus according to claim 1, further comprising a storage unit configured to store, as a transmission target, a data file designated by a user's tap operation out of data files displayed on a touch panel screen of the communication apparatus,
wherein when the communication apparatus transmits data, the communication unit transmits a data file stored in said storage unit to the other communication apparatus.

5. The apparatus according claim 1, wherein the first user instruction is input together with designation of a first data file.

6. The apparatus according to claim 1, wherein said determination unit determines the instruction which is performed firstly based on a timing at which the first user instruction is detected by said detection unit and a timing at which the second user instruction is detected.

7. A control method of a communication apparatus, comprising:
a detection step of detecting a first user instruction for turning on a communication unit of the communication apparatus;
a determination step of determining, out of the first user instruction detected in the detection step and a second user instruction for turning on a communication unit of another communication apparatus, an instruction which is performed firstly; and
a communication step of transmitting or receiving data designated by a user between the communication apparatus and the other communication apparatus based on a determination result in the determination step.

8. A non-transitory computer-readable storage medium storing a computer program for causing a computer to operate as the communication apparatus defined in claim 1.
